(19) United States
(12) Patent Application Publication
(10) Pub. No.: US 2018/0116902 A1
(43) Pub. Date: May 3, 2018

(54) MAT WITH MASSAGE BALL AND RELATED SYSTEMS AND METHODS

(71) Applicant: Varidesk, LLC, Coppell, TX (US)

(72) Inventor: David PATTON, Flower Mound, TX (US)

(21) Appl. No.: 15/796,267

(22) Filed: Oct. 27, 2017

Related U.S. Application Data
(60) Provisional application No. 62/414,370, filed on Oct. 28, 2016.

(51) Int. Cl. A61H 15/00

(52) U.S. Cl. CPC A61H 15/00; A61H 2205/12; A61H 2015/0014; A61H 2201/0119; A61H 2015/0064

(57) ABSTRACT

A massage mat system includes a mat having an upper surface; a track defined in the upper surface; and a ball-shaped massage roller, wherein the track is dimensioned to receive a first portion of the ball-shaped massage roller while a second portion of the ball-shaped massage roller protrudes from the track above the upper surface of the mat. The ball-shaped massage roller is rotatable along the track through contact between the second portion of the ball-shaped massage roller and a user's foot.

### CROSS-REFERENCE TO RELATED APPLICATIONS

This application claims priority to U.S. Provisional Application Ser. No. 62/414,370, filed on Oct. 28, 2016, the content of which is hereby incorporated herein by reference in its entirety.

### TECHNICAL FIELD

The present invention relates generally to devices, systems, and methods for massaging a part of the human body, and more specifically, to a mat including one or features for massaging the human foot.

### BACKGROUND

Users that sit at desks often times sit for long periods of time without using their legs. At the same time, the foot has several points of contact that allow for advantages when stimulated, for example, through massage. What is thus needed are therapeutic tools to massage the foot and relieve conditions such as plantar fasciitis and adult attention deficit disorder (ADD) while sitting.

### SUMMARY

According to an embodiment, a massage mat system can include a mat having an upper surface; a track defined in the upper surface; and a ball-shaped massage roller, wherein the track is dimensioned to receive a first portion of the ball-shaped massage roller while a second portion of the ball-shaped massage roller protrudes from the track above the upper surface of the mat. The ball-shaped massage roller is rotatable along the track through contact between the second portion of the ball-shaped massage roller and a user's foot.

According to another embodiment, a massage mat system can include a mat comprising an upper surface, the upper surface comprising a substantially planar portion surrounded by a left border region, a right border region, and a rear border region extending from the left border region to the right border region, wherein the left border region, the right border region, and the rear border region project upwardly from the substantially planar portion at an incline; and a massage ball located on the mat, wherein the massage ball defines a portion of a sphere that projects upwardly from the upper surface of the mat.

According to another embodiment, a massage mat system can include a mat having an upper surface; a first track and a second track defined in the upper surface; and a massage roller, wherein the massage roller includes a first wheel and a second wheel configured to roll within the first track and the second track, respectively.

Additional features, advantages, and embodiments of the invention are set forth or apparent from consideration of the following detailed description, drawings and claims. Moreover, it is to be understood that both the foregoing summary of the invention and the following detailed description are examples and intended to provide further explanation without limiting the scope of the invention as claimed.

### BRIEF DESCRIPTION OF THE DRAWINGS

FIGS. 1A-1C show perspective views of a mat with a massage roller located in various positions, according to an embodiment.

FIG. 2 shows a perspective view of a mat with a massage roller receiving portion or track, according to an embodiment.

FIG. 3 shows a top view of the mat of FIG. 2.

FIG. 4 shows a lateral cross-sectional view of the mat of FIG. 2.

FIG. 5 shows a bottom view of the mat of FIG. 2.

FIG. 6 shows a front view of the mat of FIG. 2.

FIG. 7 shows a side view of the mat of FIG. 2.

FIG. 8 shows a perspective view of a mat with a massage roller track, according to another embodiment.

FIG. 9 shows a top view of the mat of FIG. 8.

FIG. 10 shows a lateral cross-sectional view of a portion of the mat of FIG. 8.

FIG. 11 shows a perspective view of a mat having a massage roller track as an insert, according to an embodiment.

FIG. 12 shows a top view of the mat of FIG. 11.

FIG. 13 shows a front view of the mat of FIG. 11.

FIG. 14 shows a lateral cross-sectional view of a portion of the mat of FIG. 11.

FIG. 15 shows a perspective view of a massage roller track insert, according to an embodiment.

FIG. 16 shows a top view of the insert of FIG. 15.

FIG. 17 shows a cross-sectional view of the insert of FIG. 16 taken along line 17-17 of FIG. 16.

FIG. 18 shows a front view of the insert of FIG. 15.

FIG. 19 shows a perspective view of a contoured mat with a stationary, recessed massage roller, according to an embodiment.

FIG. 20 shows an exploded view of the mat of FIG. 19.

FIG. 21 shows a perspective view of a mat with a protruding massage roller, according to an embodiment.

FIG. 22 shows an exploded view of the mat of FIG. 21.

FIG. 23 shows a perspective view of a mat with an elongated massage roller, according to an embodiment.

FIG. 24 shows a top view of the mat of FIG. 23.

FIG. 25 shows a front view of the mat of FIG. 23.

FIG. 26 shows a lateral cross-sectional view of the mat of FIG. 23.

FIG. 27A shows a perspective view of an embodiment of the massage roller of FIG. 23.

FIG. 27B shows a side view of the massage roller of FIG. 27A.

FIG. 28 shows a perspective view of another embodiment of the massage roller of FIG. 23.

FIG. 29 shows a perspective view of yet another embodiment of the massage roller of FIG. 23.

FIG. 30 shows a top view of the mat of FIG. 23.

FIG. 31 shows a front view of the mat of FIG. 23.

FIG. 32 shows a side-view of the mat of FIG. 23.

FIG. 33 shows a lateral cross-sectional view of the mat of FIG. 30.

FIG. 34 shows a perspective view of a massage roller track insert, according to an embodiment.

FIG. 35 shows a top view of the insert of FIG. 34.

FIG. 36 shows a lateral cross-sectional view of the insert of FIG. 34 taken along line 36-36 of FIG. 35.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention.

Embodiments of the invention relate to a mat, for example, that can rest on the floor or other surface, and can be operated by a user to massage or otherwise contact a portion of their body, such as the foot, for example, in a therapeutic manner. For example, embodiments can include a planar, flat, non-planar, or contoured mat. Embodiments can also include a raised feature, such as a ball, that can be used to flex, stretch, or massage a portion of the body, such as the foot. According to embodiments, the raised feature may include one or more massage rollers that rotate in or on the mat. According to an embodiment, the user can move their his or her foot or other body part back-and-forth across the massage roller, thereby massaging or otherwise treating the body part. Embodiments envision the user seated while using the mat (e.g. sitting at a traditional desk, or at a lowered standing desk), or standing while using the mat (e.g. standing at a raised standing desk). Additionally, embodiments can be used to treat other parts of the body, for example, such as the hands, forearms, or face.

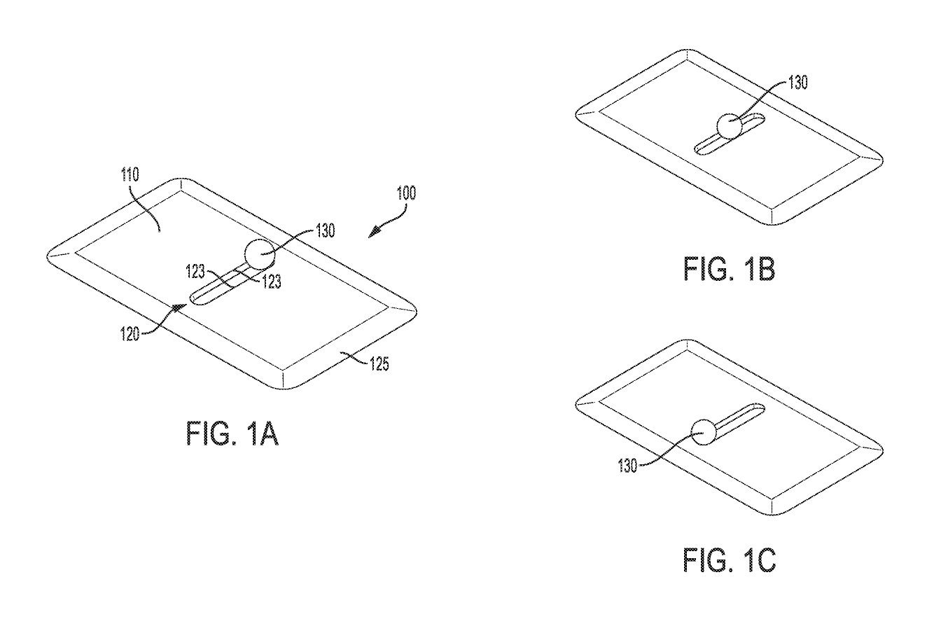

Referring to FIGS. 1A-1C, a perspective view of mat 100 is shown. The mat 100 can have a track 120 with one or more massage rollers 130 received therein. As shown, the mat 100 can include an upper surface 110. The upper surface 110 can be substantially planar. The mat 100 can include an opposite lower surface or base configured to rest on a surface, such as, for example, but not limited to, a floor, a table, or a desk. The upper surface 110 of the mat 100 can be configured to support a body part, such as, for example, but not limited to, a foot, a hand, or an arm of a user thereon. The mat 100 can include one or more tracks 120 that are disposed in the upper surface 110 to receive the massage roller 130. The massage roller 130 can roll or rotate within track 120. For example, the massage roller 130 can rotate in place or roll back-and-forth in the track 120 as described in more detail below. As shown in FIG. 1, the track 120 can comprise a depression or a cut-out of the upper surface 110. The track 120 can be configured to receive an object, such as a rolling object, such as a massage roller 130. The massage roller 130 can be, for example, but not limited to, a ball, a sphere, or other substantially round or curved object that is capable of rolling along or rotating within the track 120. As the massage roller 130 rolls along or rotates within the track 120, the massage roller 130 can make contact on opposing edges, such as sidewalls 123, of the track 120. Thus, the track 120 can facilitate rotation or rolling of the massage roller 130 through contact with the at least one foot or other body parts of the user. The track 120 can have sidewalls 123 that are substantially perpendicular to the upper surface 110; however, other embodiments are possible, such as, for example, but not limited to inwardly tapered sidewalls, outwardly tapered sidewalls, curved sidewalls, or sloped sidewalls. In the embodiments of ball-shaped massage rollers descripted throughout this description, the ball-shaped massage rollers can have a diameter of between, for example, about 50 mm and about 100 mm, however, other sizes are possible.

As shown in FIGS. 1A-1C, the mat 100 can include a tapered outer edge 125. The track 120 can include an elongated recess in the upper surface 110 of the mat. Alternative shapes and configurations of track 120 are possible, such as, for example, but not limited to a depression, cut-out, curved track, oval track, or angled track, etc. The track 120 can extend through a portion of upper surface 110 such that a base of the mat 100 is visible in the track 120. Alternatively, the track 120 can extend through the mat 100 such that the surface (e.g. a floor or table) on which the mat 100 is placed is visible in the track 120. The track 120 can include a ball receiving portion. The ball receiving portion of track 120 can be configured to complement the outer surface of the massage roller 130.

With continued reference to FIGS. 1A-1C, movement of the massage roller 130 within the track 120 can be appreciated. The massage roller 130 can have a starting position, such as at an end (FIG. 1A or FIG. 1C) of the track 120 or at a center (FIG. 1B) of the track 120. During use, the user can apply pressure to the massage roller 130 with a body part, such as, for example, a foot, to move the massage roller 130 along the length of the track 120. For example, the user can apply pressure to a front side or rear side of the massage roller to move the massage roller 130 forward and backward to opposing ends of the track 120. Alternatively, the user can apply pressure in a top-down manner on the massage roller 130 to rotate the massage roller 130 in a stationary place within the track 120. Although the massage roller 130 is depicted in FIGS. 1A-1C as a sphere, it can be appreciated that other shapes and configurations of massage roller 130 can be provided.

The mat 100 can be made of a variety of materials including, for example, but not limited to, plastic, hard plastic, rubber, hard rubber, wood, metal, a deformable material, an elastic material, a shape-memory alloy, or foam. According to the embodiment shown in FIGS. 1A-1C, the mat 100 can include beveled, no-curl edges 125 that border a higher density core.

The massage roller 130 can be made of a variety of materials including, for example, but not limited to, a durable material, a hard plastic, hard rubber, metal, wood, a deformable material, an elastic material, a shape-memory alloy, a foam, or a material filled with a gel. The mat 100 can be made of the same or different material as the massage roller 130. As a ball, the massage roller 130 can be made of a deformable material and/or deformable structure. In an embodiment, the ball can be a tennis ball, or other ball sized and shaped to be received within the track 120. According to an embodiment, a set of massage rollers 130 having different hardnesses (e.g., soft, medium, and hard) can be provided, so the user can select a massage roller 130 having the desired hardness.

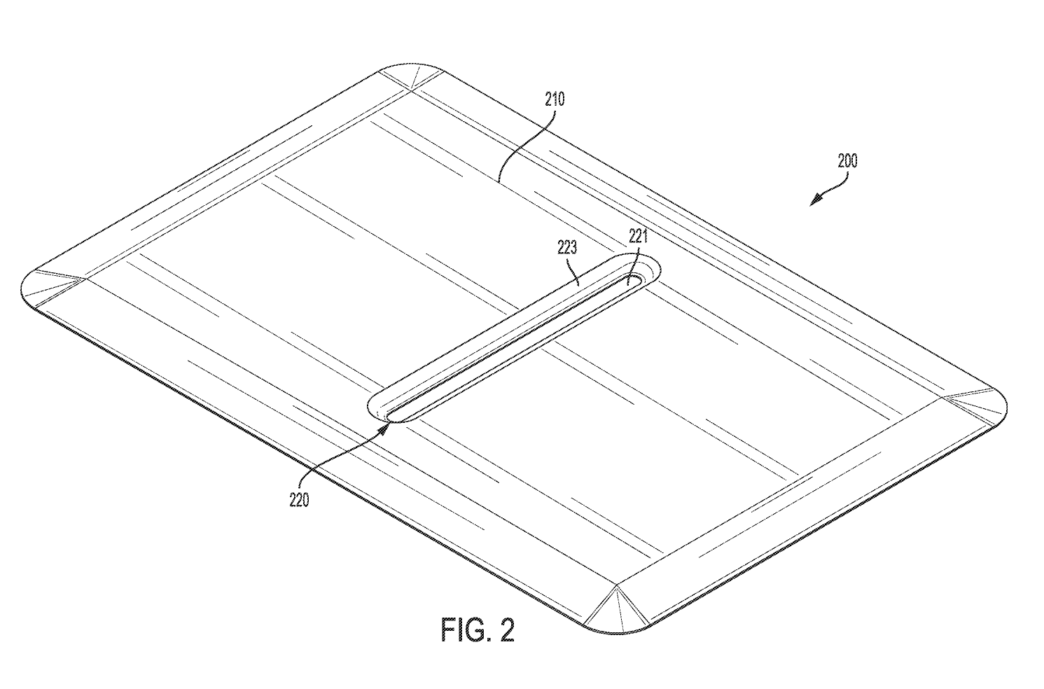

FIG. 2 shows a perspective view of an alternate embodiment of a mat. The mat 200 can be the same or similar as the mat 100 except the track 220 has sidewalls 223 that are curved, for example, to match the curvature of the massage roller (not shown). As seen from FIG. 2, the sidewalls 223 of the track 220 can be one unitary sidewall that seamlessly curves around in an oblong bowl shape. The track 220 can outline a hole 221 that extends through to the underside of the mat 200. The track 220 can be a groove that runs along an axis of the upper surface 210. The groove can have a width that accommodates a ball to roll thereon. Alternatively, the track 220 can extend partially through the upper surface 210 such that a portion of the mat 200 defines the bottom surface of the track 220.

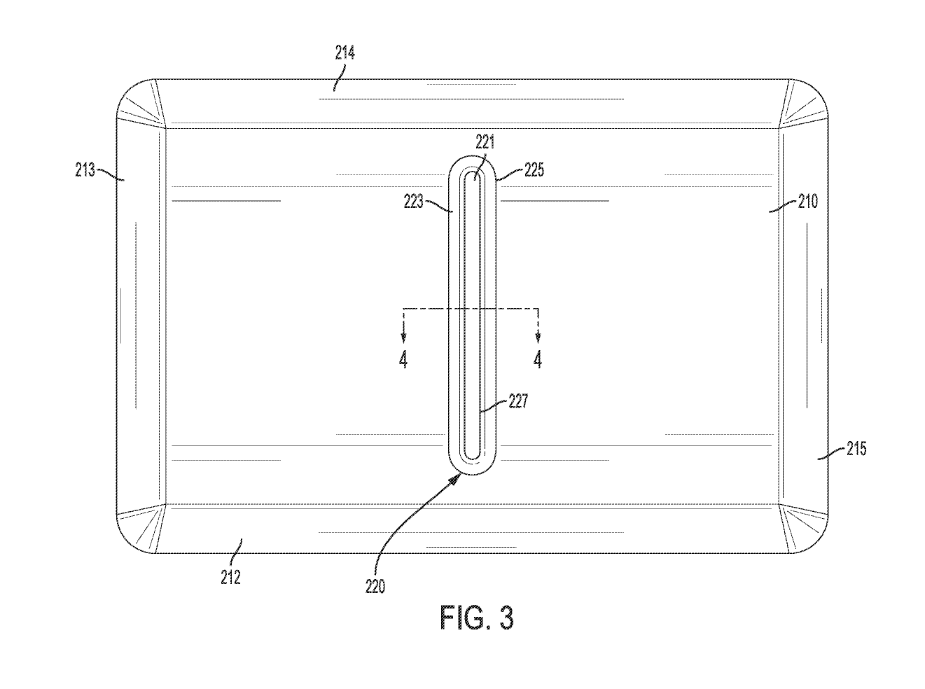

FIG. 3 shows a top view of the mat 200. Track 220 of mat 200 can have an elongated shape with rounded ends. The track 220 can have an upper edge 225 at the top of track 220 and a lower edge 227 at a base of the track 220. The upper edge 225 can be joined to the lower edge 227 by the sidewalls 223. As mentioned previously, the upper edge 225, lower edge 227, and sidewalls 223 can collectively define an elongated shape with rounded ends. The sidewalls 223 can taper inward or outward from upper edge 225 to lower edge 227. Alternatively, the sidewalls 223 can be substantially straight or have other shapes that complement that massage roller (not shown) received therein. The mat 200 can have borders 212, 213, 214, 215 that can slope or taper downward from the upper surface 210 to the base of mat 200 or to the floor, so as to reduce curling of the edges of the mat 200. Alternatively, the borders 212, 213, 214, 215 can be substantially perpendicular to upper surface 210.

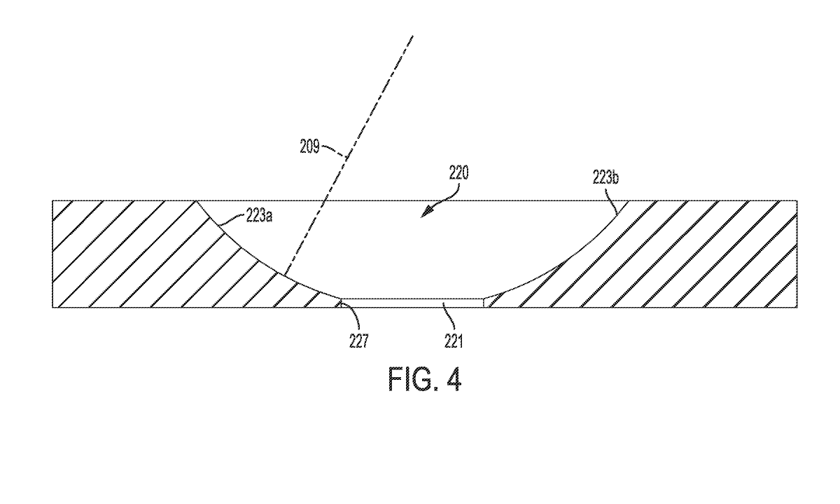

FIG. 4 shows a lateral cross-sectional view of a portion of the mat 200 along an axis of the mat 200. As can be seen, the track 220 can comprise opposing sidewalls 223a and 223b. The opposing sidewalls 223a, 223b can have mirror-image curvatures separated by the hole 221. With continued reference to FIG. 4, a cross-sectional curvature 209 of the sidewalls 223a, 223b can be in a shape of a partial circle. The radius of the cross-sectional curvature 209 can correspond to the radius of the massage roller (not shown), for example, the radius of the cross-sectional curvature 209 can be the same as, or slightly larger or smaller than the radius of the massage roller. Although the opposing sidewalls 223a, 223b are shown with concave curvatures, it will be understood that other profiles for sidewalls 223a, 223b can be provided. For example, the opposing sidewalls 223a, 223b can have convex curvatures, tapered profiles, angled profiles, or substantially straight or perpendicular profiles. The opposing sidewalls 223a, 223b can have a shape or profile which complements or mates with an outer surface of the massage roller (not shown).

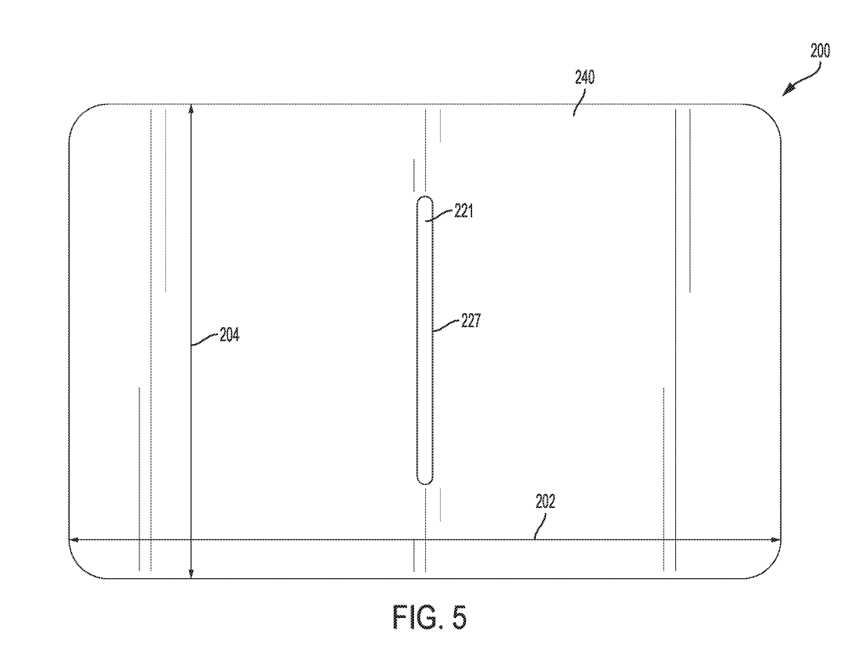

Referring now to FIG. 5, a bottom view of mat 200 is shown. The mat 200 can include a base or underside 240. As can be seen, the edge 227 of the base adjacent to the hole 221 can have an elongated shape with rounded ends, although other embodiments are possible. The mat 200 can be substantially rectangular and have a width 202 and a length 204. The width 202 can be longer than the length 204. Alternatively, the width 202 can be the same distance as or shorter than the length 204. Alternatively, the mat 200 can be other shapes, such as, for example, but not limited to, elliptical, circular, or other shape. In an embodiment, the mat 200 can have a width 202 of between about 700 mm and about 1,100 mm, a length 204 of between about 400 mm and about 800 mm, and a thickness (not labeled) of between about 100 mm and about 300 mm. The track 220 can extend for a distance of between about 250 mm and about 450 mm and can have a width of between about 20 mm and about 40 mm at the top surface and a width of between about 5 mm and about 15 mm at the bottom surface. The radius of curvature of the sidewalls can be between about 30 mm and about 50 mm.

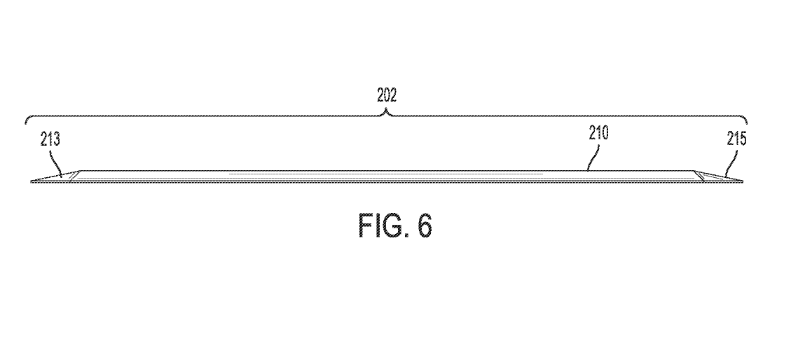

FIG. 6 shows a side-profile view along a width 202 of the mat 200. The mat can include borders 213 and 215 located on opposing sides of the width 202 of the mat 200. The borders 213 and 215 can be tapered. A side-profile of the borders 213, 215, which border the width 202 of the mat 200, can have an inclined or triangular shape.

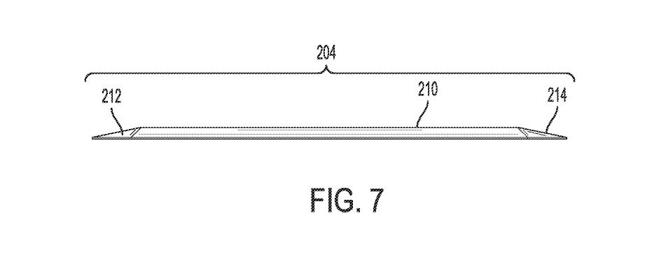

FIG. 7 shows a side-profile view along a length 204 of a mat, according to an embodiment. The mat can include borders 212 and 214 located on opposing sides of the length 204 of the mat 200. The borders 212 and 214 can be tapered. A side-profile of the borders 212, 214, which border the length 204 of the mat 200, can have an inclined or triangular shape.

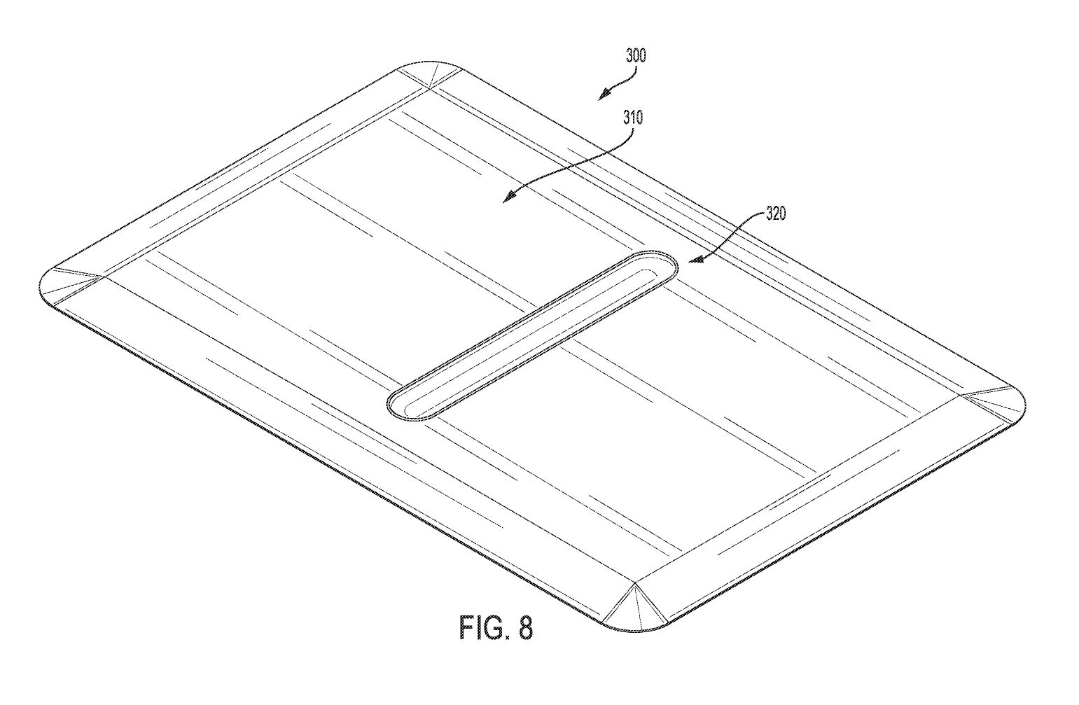

Referring to FIG. 8, a perspective view of another embodiment of a mat is shown. The mat 300 can include a track 320. The track 320 can comprise a depression in the upper surface 310 of mat 300 that does not extend completely through the mat 300. The track 320 can be shaped as a partially cylindrical trough having a continuous or semi-continuous curved point of contact that interfaces with a massage roller (not shown). The track 320 can be shaped to make contact with two or more points on the massage roller (not shown), which can be a ball or other object.

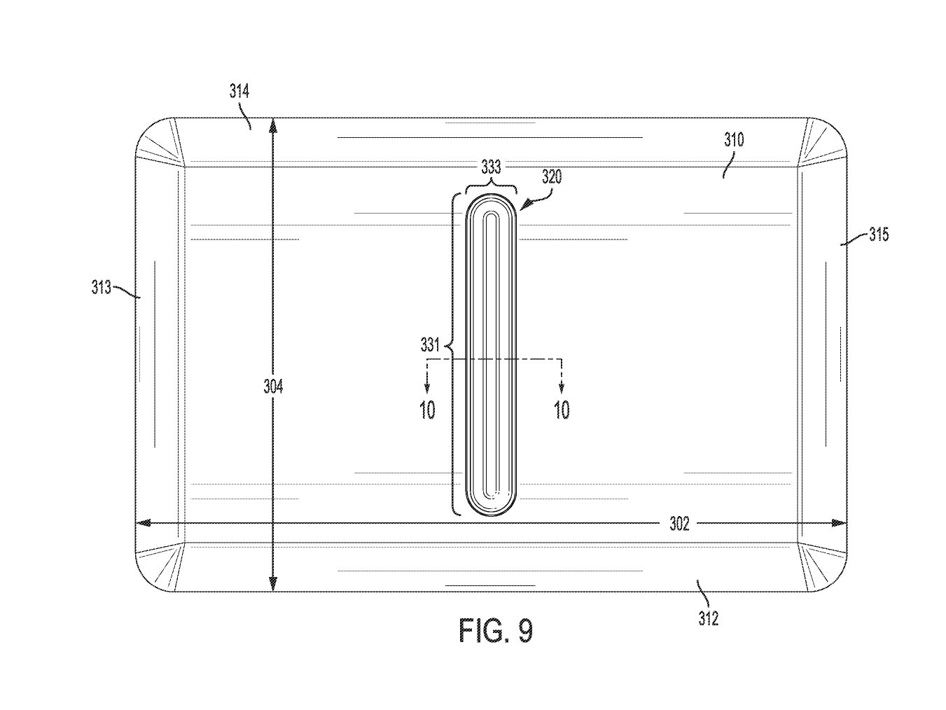

FIG. 9 shows a top view of the mat 300 of FIG. 8. The track 320 can have an elongated shape with rounded ends. The mat 300 can be substantially rectangular and have a width 302 and a length 304. The width 302 of the mat 300 can be longer than the length 304. In another embodiment, the width 302 can be the same distance as or shorter than length 304. Alternatively, the mat 300 can be other shapes, such as, for example, but not limited to elliptical, circular, or other shape. The mat 300 can have borders 312, 313, 314, 315 that can slope or taper downward from the upper surface 310 to the base of mat 300 or to the floor. Alternatively, the borders 312, 313, 314, 315 can be substantially perpendicular to upper surface 210.

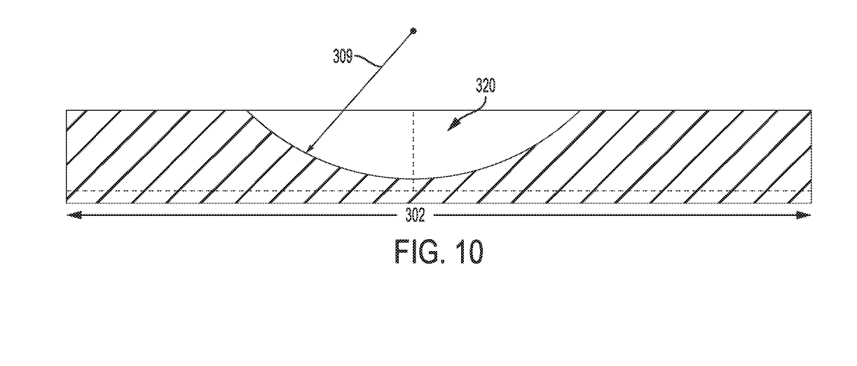

FIG. 10 shows a lateral cross-sectional view of the mat 300 along an axis of the mat 300. The track 320 can have a curved profile. The track 320 can be in a shape of a partial circle. The radius 309 of the partial circle can correspond to the radius of a massage roller or to the radius of a component of the massage roller (not shown). The radius 309 can by the same as, or slightly larger or smaller than the radius of the massage roller. Although the profile of track 320 is shown as a concave curve, it is understood that other profiles can be provided. For example, the profile of track 320 can be convex, tapered, angled, or substantially straight or perpendicular. The profile of track 320 can have a shape or profile which complements or mates with an outer surface of the massage roller (not shown).

In an embodiment, the mat 300 can have a width 302 of between about 700 mm and about 1,100 mm, a length 304 of between about 400 mm and about 800 mm, and a thickness (not labeled) of between about 100 mm and about 300 mm. The track 320 can extend for a distance 331 of between about 250 mm and about 450 mm and have a width 333 of between about 5 mm and about 15 mm. The radius 309 can be between about 30 mm and about 50 mm.

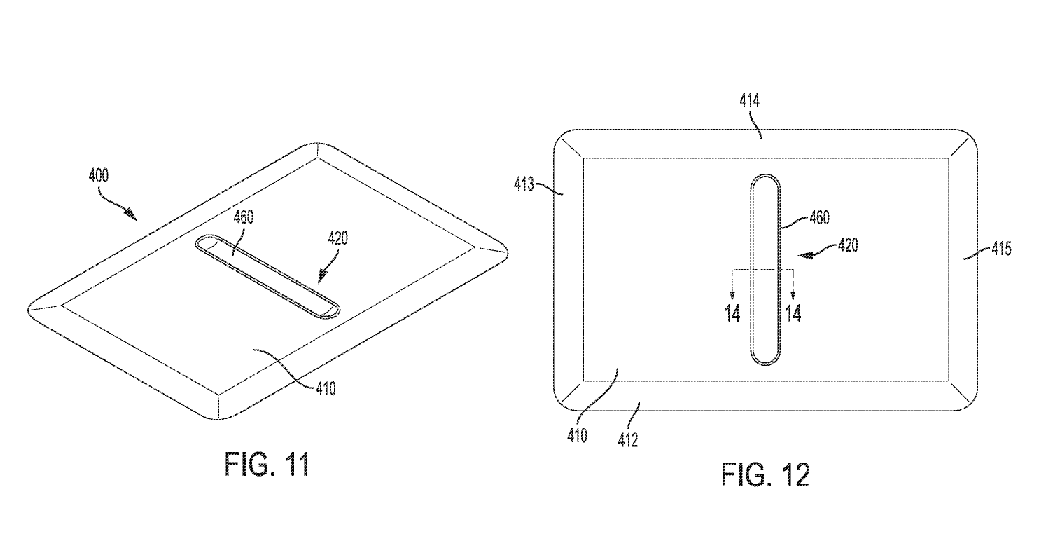

FIG. 11 shows a perspective view of another embodiment of a mat. The mat 400 can include a track 420 provided in an upper surface 410. The track 420 can include an insert 460 received therein. FIG. 12 shows a top view of the mat 400. A region of the mat corresponding to track 420 can be cut out, forming a void within a portion of the mat 400 for receiving the insert 460, as will be described in more detail below. The mat 400 can have soft, no-curl borders 412, 413, 414, 415 that can slope or taper downward from the upper surface 410 to the base of mat 400 or to the floor. Alternatively, the borders 412, 413, 414, 415 can be substantially perpendicular to upper surface 410. The borders 412, 413, 414, 415 can surround a harder core.

The insert 460 can comprise a hard material that interfaces with the massage roller. The insert 460 can be made of, for example, a hard plastic material or otherwise high density polyurethane material. The insert 460 can support or facilitate movement of the massage roller (not shown). The insert 460 can be deformable. The insert 460 can accommodate pressure applied on the massage roller by a user. Alternatively, the insert 460 can be added to any of mats 100, 200, or 300 to change a dimension or material of the respective tracks.

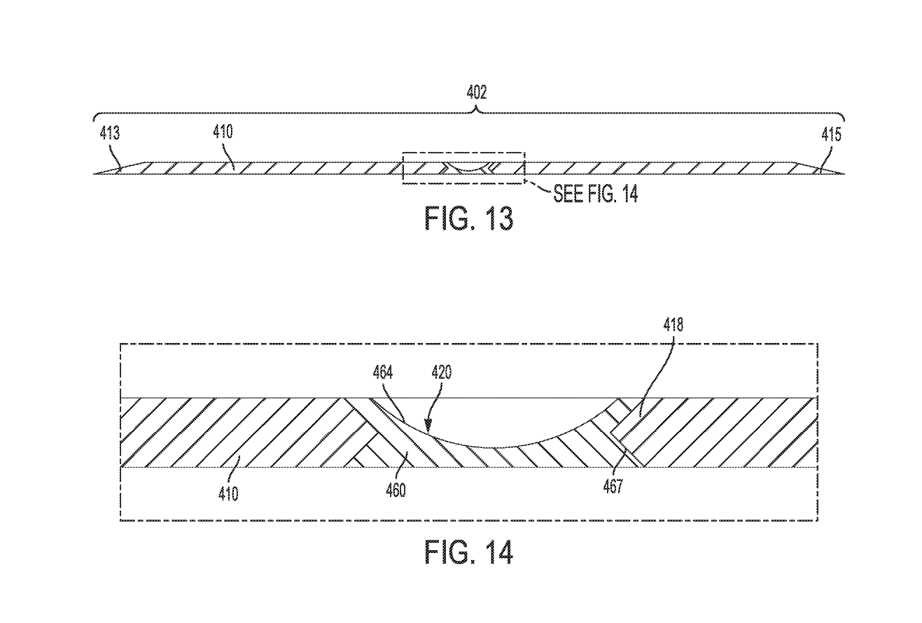

FIG. 13 shows a lateral cross-sectional view of the mat 400 along a width 402 of the mat 400. The mat include borders 413 and 415 located on opposing sides of the width 402 of the mat 400. As previously described, the borders 413 and 415 can be tapered. A side-profile of the borders 413, 415, which border the width 402 of the mat 400, can have an inclined or triangular shape. The side-profile geometry of the borders 412 and 414 located on opposing sides of the length of the mat 400, can be tapered or can have an inclined or triangular geometry.

FIG. 14 shows a lateral cross-sectional view of a portion of the mat 400 according to the embodiment shown in FIG. 11. As can be seen, the mat 400 can define a void 467 having a geometry that mates or interlocks with the insert 460 to hold it in place. Adhesives can optionally be used to further retain the insert 460 in place. Alternatively, the insert 460 can be retained in void 467 through friction fit or other fastening device. The insert 460 can thus fit into the void 467 and provide an interface for the massage roller (not shown).

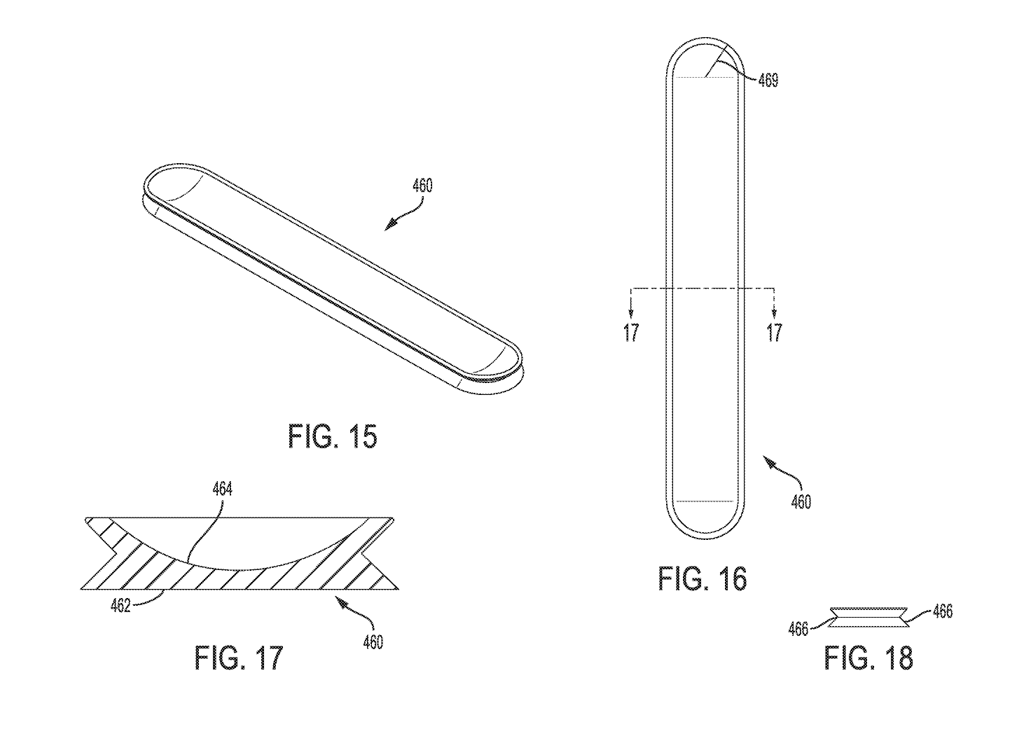

FIG. 15 shows a perspective view of the insert 460 in isolation of the mat 400. FIG. 16 is a top view of the insert 460. As can be seen from FIG. 16, the rounded ends can have a shape of a circular portion. A radius of the circular portion is depicted by 469. FIG. 17 shows a lateral cross-section of the insert 460. As can be seen in FIG. 17, the insert 460 can have a shape of a cylindrical trough having a flat base 462 and a profile 464 that interfaces with the massage roller. The profile 464 can be curved. The profile 464 can be larger, smaller, or the same radius as an outer surface of the massage roller (not shown). FIG. 17 shows that a cross-sectional curvature of the curved top portion or profile 464 can be in a shape of a partial circle, however, other shapes that interface with and support the massage roller are also possible. FIG. 18 shows a front/rear view of the insert 460, where the side walls include indents 466, which can interface with a protruding portion 418 of the mat (shown in FIG. 14).

Although the profile 464 of the insert 460 of track 420 is shown and described as a concave curve, it is understood that other profiles can be provided. For example, the profile 464 of the insert 460 can be convex, tapered, angled, or substantially straight or perpendicular. The profile 464 of the insert 460 can have a shape or profile which complements or mates with an outer surface of the massage roller (not shown), so as to support the massage roller within the insert.

Although the tracks 120, 220, 320, and 420 are shown and described as elongate tracks located in a central portion of the respective mats 100, 200, 300, and 400, it can be appreciated that alternate shapes, configurations, and locations can be provided. The tracks 120, 220, 320, and 420, can be, for example, rotated such that they run parallel to the width (e.g. width 202) of the respective mat or such that they run at an angle with respect to the width or length of the respective mat. Other shapes and configurations of the tracks 120, 220, 320, and 420 are also considered. For example, the tracks can be curved, oval, circular, or angled, etc. It can be appreciated that any number of combinations of size, location, and shape of the tracks can be provided. Additionally, the upper surfaces 110, 210, 310, 410 can be substantially planar or non-planar.

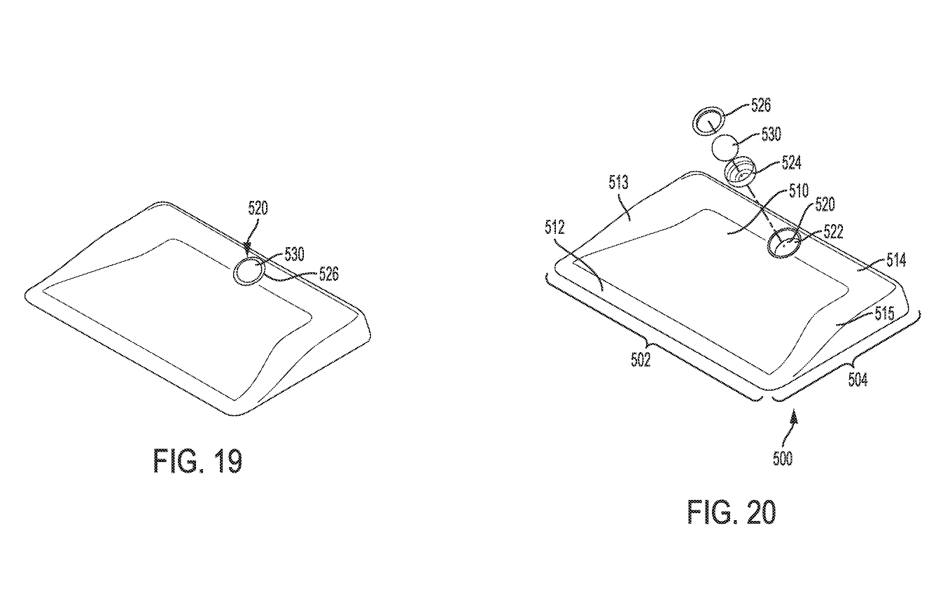

FIGS. 19 and 20 show a perspective view of another embodiment of a mat. The mat 500 includes an upper surface 510. The upper surface 510 can be substantially non-planar. The upper surface 510 can be a multi-contoured surface. The mat 500 can include a protruding massage roller 530. As shown in FIG. 20, mat 500 can include a track 520. The track 520 can receive a massage roller 530, such as, for example, a ball. The track 520 can have a cylindrically-shaped recess 522 in the upper surface 510 of the mat 500. The track 520 can include a massage roller holder 524 that is configured to fit inside the cylindrically-shaped recess 522. The massage roller holder 524 can be a ball holder. The track 520 can also include a massage roller cover 526 that is configured to retain the massage roller 530 within the massage roller holder 524. The massage roller cover 526 can be a ball cover. Thus, a ball can be retained within a ball holder with a ball cover. The cylindrically-shaped recess 522 can have a circular cross-section. The axis of cylindrically-shaped recess 522 can be inclined with respect to the thickness direction of the mat 500 (as shown), or alternatively, can be substantially parallel to the thickness direction of the mat 500.

The mat 500 can be shaped as a rectangle, although various other shapes such as, for example, a square, a circle, an oval, or a polygon are contemplated within the broad inventive principles described herein. The mat 500 can have a width 502 and a length 504. The width 502 can be different than the length 504 that is perpendicular to the width 502. The width 502 of the mat can be longer than the length 504. Alternatively, the width 502 can be shorter than or equal to the length 504. The width 502, length 504, and thickness can be similar to previously-described embodiments of a mat. FIG. 19 shows that when the massage roller 530 is retained in the track 520, the massage roller can be rotated or spun by a user while remaining stationary inside the track 520, for example, using his or her foot.

FIG. 19 shows that the contour of the upper surface of the mat 500 can be uneven in certain portions. For example, as seen from FIG. 20, the left border region 513, rear border region 514, and right border region 515 can be raised above the middle substantially planar portion as raised, contoured edges. Front border region 512 can maintain a tapered side profile to accommodate a user's feet to enter the mat 500. The upper surface 510 of the mat can have the raised portions located at the periphery of the mat. The raised portions can allow a user's foot or other body part to rest thereon in relation to the massage roller 530. The raised portions can also provide a border to direct a user's foot or other body part into the center region of the mat 500. The raised portions can also allow a user to target the stretching of certain muscles, for example, in the leg. The mat 500 can taper from a back edge (back edge of rear border region 514) to a front edge (front edge of front border region 512). Although border regions 513, 514, and 515 are depicted and described as being raised with respect to a central portion of the upper surface 510, it can be appreciated that any of one or more or all of border regions 512, 513, 514, and 515 can be raised with respect to other portions of the upper surface 510.

According to embodiments, the track 520 and massage roller 530 can be located on the upper surface of mat 500 at a central position along the width 502 of the mat 500, and can be located at a rear position along the length 504 of the mat 500, however other locations are possible. For example, the track 520 and massage roller 530 can be centered along both the width 502 and the length 504. Alternatively, for example, the track 520 and massage roller 530 can be centered along the length 504 and positioned toward a right side or a left side of the width 502. Any number of locations on the mat 500 are contemplated for the track 520 and massage roller 530.

According to the specific embodiment shown, the front border region 512 transitions into the substantially planar middle portion, which can slope gradually upward until it intersects with the abruptly-raised rear border region 514. The substantially planar middle portion can also intersect with the abruptly-raised left and right border regions 513, 515. As shown in FIG. 20, the left and right border regions 513, 515 can increase in height with increased distance from the front border region 512. The mat 500 thus slopes slightly upward and is bordered on the left, rear, and right sides by the border regions 513, 514, 515. The massage roller 530 can project upward from a portion of the mat in order to facilitate contact with the user's foot or other body part. The raised left, rear, and right borders 513, 514, 515 can provide a structure for the user to incline his or her feet on, for example, to stretch the calf muscles, however, other uses are envisioned.

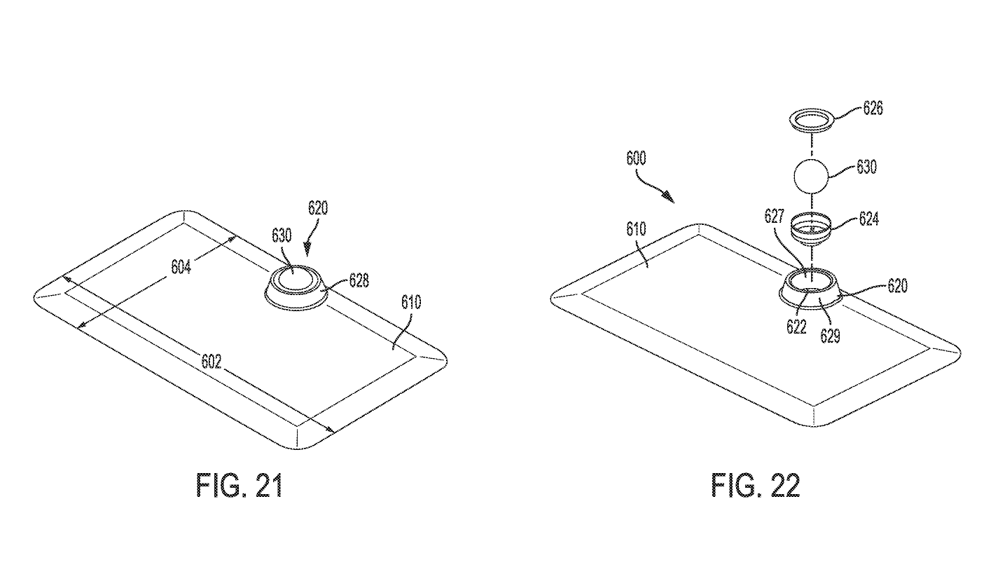

FIGS. 21 and 22 show a perspective view of another embodiment of a mat 600. The mat 600 can be the same or similar to the mat 500 of FIGS. 19-20, except that the upper surface 610 of the mat 600 can be substantially horizontal with respect to a base of the mat 600. The upper surface 610 can be flat or substantially flat, planar, non-planar, or multi-contoured. As shown in FIG. 22, the track 620 can include a lip 628 that protrudes upward from the upper surface 610. The lip 628 can include a conical exterior wall 629 and an interior wall 627 that is located at or above the adjacent surface of the upper surface 610. The track 620 can include a recess 622 to receive a massage roller holder 624, with the recess being at or above the upper surface 610. The lip 628 or the interior wall 627 of the lip 628 can receive a massage roller 630. In this regard, although the embodiment of FIGS. 19-20 has a massage roller 530 that is at least partially recessed beneath the surface of the substantially planar portion of upper surface 610, the embodiment of FIG. 21 can have substantially all, or a majority, of the massage roller 630 elevated above the upper surface 610. The track 620 can include a massage roller holder 624 that is configured to fit inside the recess 622. The track 620 can also include a massage roller cover 626 that is configured to retain the massage roller 630 within the massage roller holder 624.

The cylindrically-shaped recess 622 can have a circular cross-section. The axis of cylindrically-shaped recess 622 can be substantially parallel to the thickness direction of the mat 600 (as shown), or alternatively, can be inclined with respect to the thickness direction of the mat 600.

In an embodiment, the width 602 of the mat 600 can be longer than the length 604. In other embodiments, the width 602 can be shorter than the length 604. The mat 600 can be shaped as a rectangle, although various other shapes such as, for example, squares, circles, or ovals are contemplated within the broad inventive principles described herein. The mat 600 can have a width 602, length 604, and thickness similar to those previously described in connection with other embodiments.

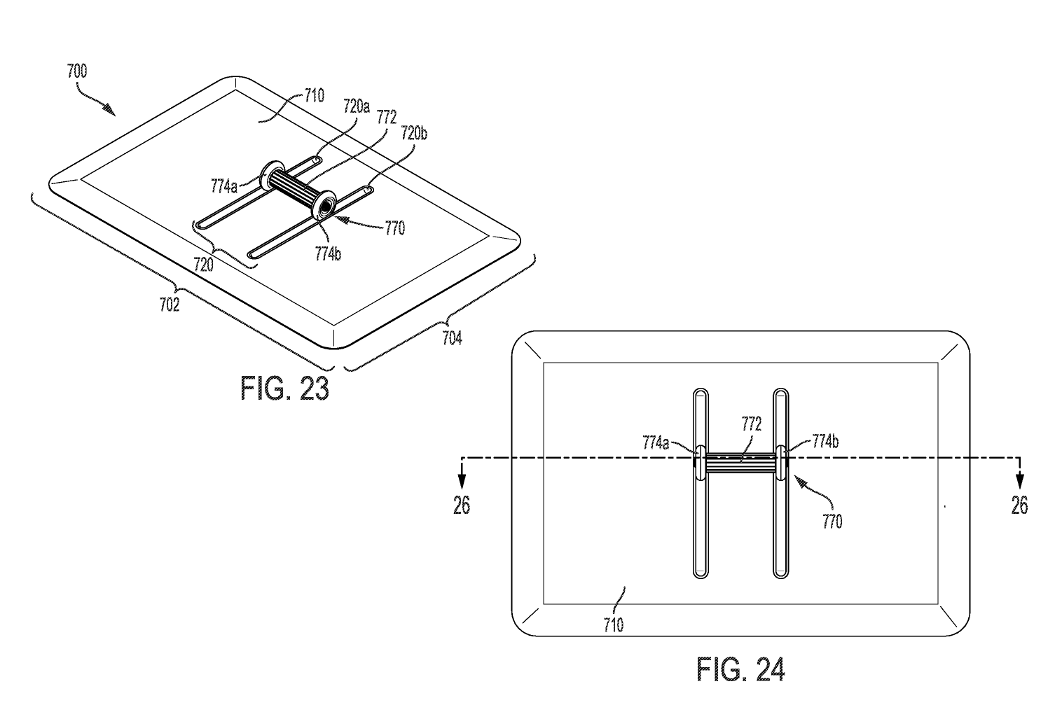

FIG. 23 shows a perspective view of another embodiment of a mat 700 having an elongated, generally cylindrical massage roller 720. As shown, the mat 700 has two tracks 720a, 720b. The tracks 720a, 720b can be in the form of a double channel groove. The double channel groove can have parallel tracks 720a, 720b that are substantially equal in length. In an embodiment, the double channel groove can extend along a length 704 of the mat 700. The tracks 720a, 720b can be configured to receive a massage roller 770 in substantially the shape of a dumbbell with opposing cylindrical wheels 774a, 774b adapted to run in the corresponding tracks 720a, 720b. The opposing rolling wheels 774a, 774b can be configured to roll with respect to a body 772 of the massage roller 770. The massage roller 770 can have a connecting shaft or cylindrical body 772 that comprises a plurality of massaging protuberances or other features as described in more detail below. Although the tracks 720a, 720b are depicted as generally elongated and aligned along the length direction 704 of mat 700, other shapes and configurations of the tracks 720a, 720b can be provided. For example, the tracks 720a, 720b can be curved, angled with respect to width 702 and/or length 704, or aligned along the width direction 702.

A user can place a foot or other body part on the cylindrical body 772 and roll the massage roller 770 along the tracks 720a, 720b. Alternatively, or additionally, the user can place the foot or other body part on one or both of the cylindrical wheels 774a, 774b, and can rotate the massage roller 770 along the tracks 720a, 720b in a similar manner. Further, the user can roll the massage roller 770 by simultaneously placing two feet on the roller object either on opposing cylindrical wheels 774a, 774b or with one foot on one of the cylindrical wheels 774a, 774b with another foot on the cylindrical body 772.

FIG. 24 shows a top view of the mat 700 with massage roller 770 of FIG. 23. As can be seen, the massage roller 770 can have a substantially cylindrical-shaped body 772 with opposing rolling wheels 774a, 774b. The massage roller 770 can move from a front portion of the tracks 720a, 720b to a rear portion of the tracks 720a, 720b and can be stopped at intermediary locations. The ends of the tracks 720a, 720b can be shaped to mate or otherwise accommodate the wheels 774a, 774b.

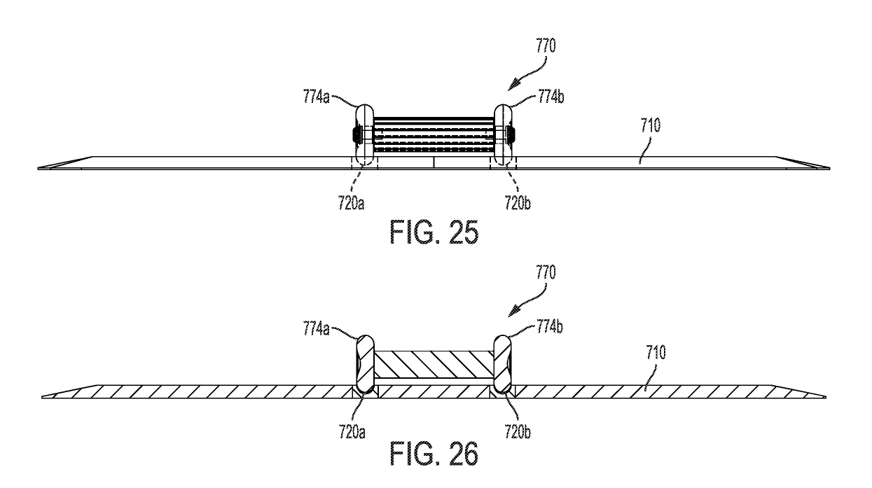

FIG. 25 shows a side view of FIG. 23. As can be seen, the wheels 774a, 774b of massage roller 770 can be partially disposed within the tracks 720a, 720b, respectively, of the mat 700. FIG. 26 shows a cross-sectional view of FIG. 24. As can be seen, the tracks 720a, 720b can have geometries that receive and substantially complement the wheels 774a, 774b; however, other mating geometries are possible.

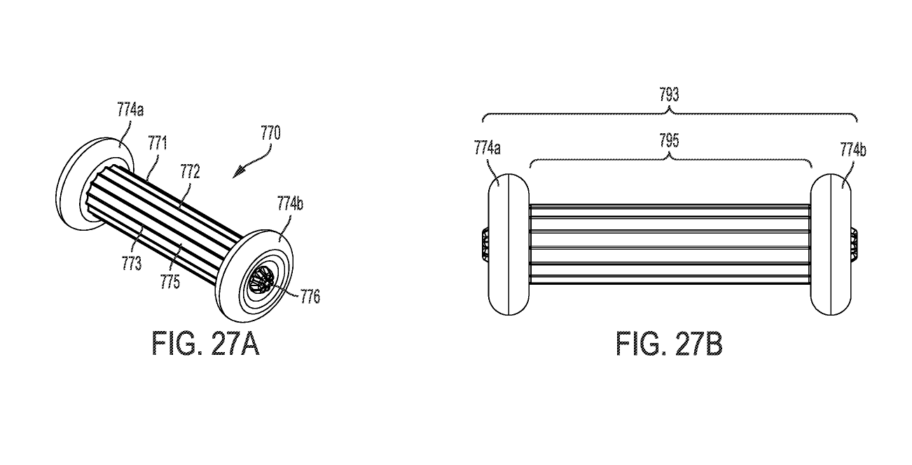

FIG. 27a shows a perspective view of an embodiment of massage roller 770. As can be seen, the body 772 can include ridges 771 that define peaks 773 and valleys 775 along a longitudinal axis of the cylindrical body 772. The massage roller 770 can also include a first rolling wheel 774a at a first end and a second rolling wheel 774b at a second end. The massage roller 770 can include a twist lock 776 or other features to retain each wheel 774a, 774b on the body 772.

FIG. 27B shows a side view of the massage roller 770. In an exemplary embodiment, the massage roller 770 can have a length 793 of between about 160 mm and about 200 mm including the wheels 774a, 774b and cylindrical body 772. The cylindrical body 772 can have a length 795 of between about 120 mm and about 160 mm and can have an outer diameter of between about 30 mm and about 50 mm. An outer diameter of the roller wheel 774a, 774b can be between about 50 mm and about 90 mm.

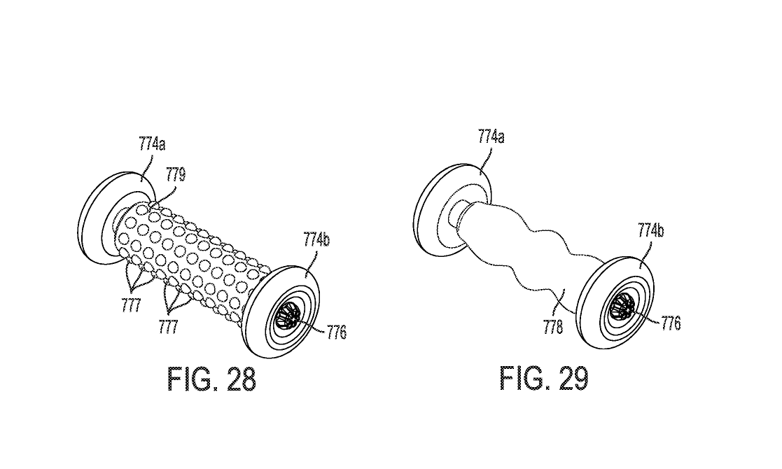

The massage roller 770 can be interchangeable with other variations such as those shown in FIGS. 28 and 29. For example, FIG. 28 shows a body 779 having a series of regularly spaced and positioned protuberances 777. The protuberances can comprise bumps. FIG. 29 shows a body 778 having a wavy surface with peaks and valleys. The wavy surface can comprise ridges. Each of the bodies 779, 778 can provide for a unique sensation to the foot of the user. Other surface features can be used, such as, for example, brushes, bristles, depressions, protuberances having a softer or harder surface than the roller or having a deformable material, protuberances being filled with a second material, such as a gel. Alternatively, it can be appreciated that the massage roller 770 can be two separate massage rollers, such as two massage rollers 130.

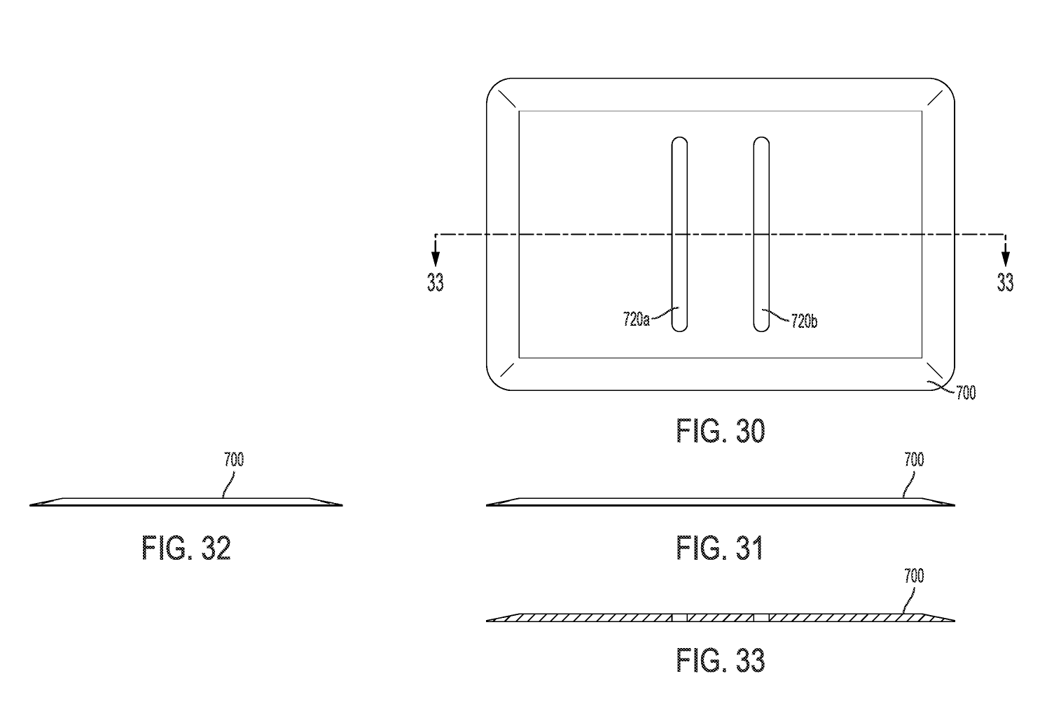

FIG. 30 shows a top view of the mat 700 of FIG. 23. Similar to previous embodiments, an exemplary mat 700 can have a width of between about 700 mm and 1,100 mm, a length of between about 400 mm and 800 mm, and a thickness of between about 100 mm and about 300 mm. The tracks 720a and 720b can run between about 250 mm and 450 mm along the mat 700 and can be between about 20 mm and 40 mm wide. The tracks 720a and 720b can be spaced apart by a distance of between about 110 mm and 150 mm from exterior borders of the channels.

FIGS. 31 and 32 show side views of the mat 700 of FIG. 30. FIG. 33 shows a cross-sectional view of the mat 700 of FIG. 30. As shown in FIG. 33, the mat 700 can include cutouts. The cutouts can receive wheels of the massage roller 770 or an insert, as will be described below.

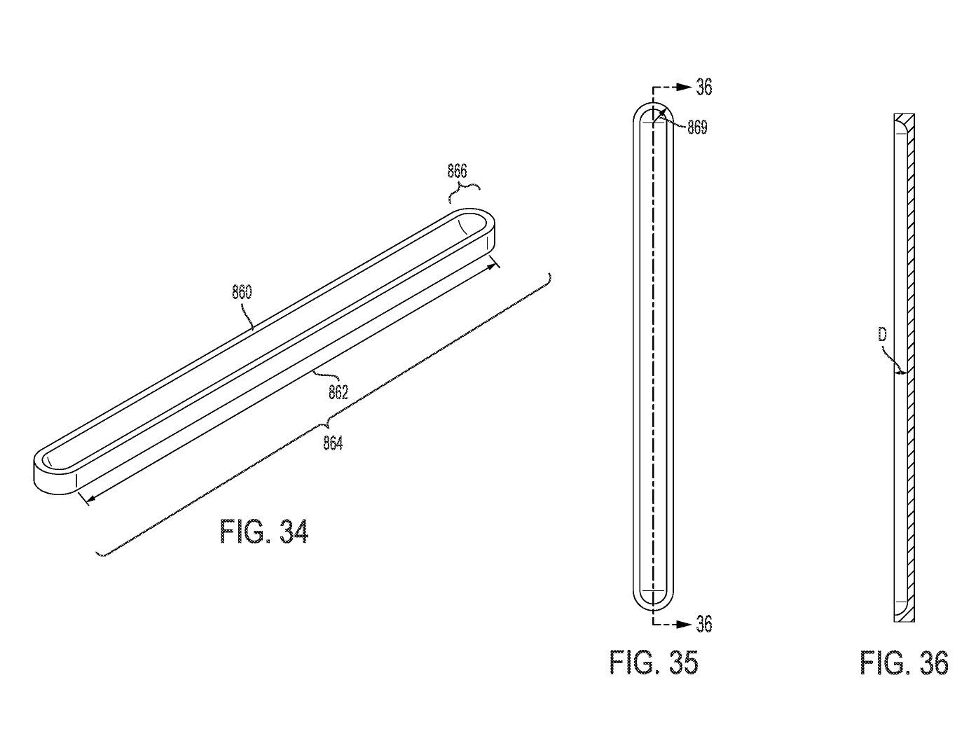

FIG. 34 shows a perspective view of an insert used in an embodiment of FIG. 30. Thus, although it is contemplated that the tracks 720a, 720b can be made from cutting out material from the mat, in other embodiments the mat material can be removed and prepared for an insert to be inserted, similar to the embodiment of FIG. 15. The length 864 of the insert 860 can be between about 250 mm and about 450 (including the rounded edges 866). Alternatively, the tracks 720a, 720b can be formed in mat 700 such that they extend only partially into the mat 700, such as is depicted in the embodiment of FIG. 10.

FIG. 35 shows a top view of the insert 860. In an exemplary embodiment, the insert 860 along portion 862 of the insert 860 can have a length of between about 250 mm and 450 mm. The insert 860 can have a width of between about 5 mm to about 15 mm from inner edge wall to inner edge wall. FIG. 35 shows that a cross-sectional curvature of the insert inner surface can be in a shape of a partial circle. A radius 869 of the partial circle can be between about 5 mm and about 15 mm.

FIG. 36 shows a cross-sectional view of FIG. 35. In an embodiment, the insert 860 can have a depth D of between about 5 mm and about 15 mm in the channel at its deepest location.

Using embodiments of the invention, a user can use the roundness of a ball-shaped massage roller to provide non-uniform pressure to the foot or feet. Based on the surface of the feet being substantially flat, the surface of the ball-shaped massage roller can provide a centrally-focused pressure to the foot (e.g., at the apex of the curvature of the ball).

The massage roller can also provide pressure to the foot or other body part. For example, using the dumbbell-shaped massage roller, a user can receive uniform pressure to the foot or feet due to the body of the dumbbell-shaped massage roller being generally cylindrical (rather than spherical). Thus, an entire cross-section of the foot can be applied with pressure from the body of the massage roller. The body of the dumbbell-shaped massage roller can also apply a non-uniform pressure to the foot by interspersing ridges or bumps to the body itself, as described above. Thus, although the body of the dumbbell-shaped massage roller can provide a substantially uniform pressure to a portion of the foot, other textures or additions can add non-uniform pressure. In addition, in combination with the cylindrical wheels, the massage roller can provide multi-directional pressure capabilities. For example, a user can receive one type of pressure from the body and receive another type of pressure from the wheel. For barefoot use, the user can use the wheels to insert toes therebetween, providing unique sensations to the user.

As can be appreciated from the foregoing disclosure any of the mats can be used with any of the massage rollers, or any combination of massage rollers. Alternative shapes, sizes, and configurations of the tracks, mats, and massage rollers are contemplated.

Although various exemplary embodiments have been described above, it should be understood that they have been presented by way of example only, and not limitation. Thus, the breadth and scope of the present disclosure should not be limited by any of the above-described exemplary embodiments, but should instead be defined only in accordance with the following claims and their equivalents.

What is claimed is:

1. A massage mat system comprising:
a mat having an upper surface;
a track defined in the upper surface; and
a ball-shaped massage roller, wherein the track is dimensioned to receive a first portion of the ball-shaped massage roller while a second portion of the ball-shaped massage roller protrudes from the track above the upper surface of the mat;
wherein the ball-shaped massage roller is rotatable along the track through contact between the second portion of the ball-shaped massage roller and a user's foot.

2. The mat system of claim 1, wherein the track comprises an elongated recess defined with respect to the upper surface of the mat, the elongated recess defining a curved, concave profile configured to receive the first portion of the ball-shaped massage roller.

3. The mat system of claim 1, wherein the track comprises an insert received within a void in the mat, wherein the mat and the insert are different materials.

4. The mat system of claim 1, wherein:
the mat defines a width of between about 700 mm and about 1,100 mm; and
the mat defines a length of between about 400 mm and about 800 mm.

5. The mat system of claim 4, wherein:
the track extends along the upper surface of the mat for a distance of between about 250 mm and about 450 mm; and
the track defines a width of between about 20 mm and about 40 mm at the upper surface of the mat.

6. The mat system of claim 1, wherein the mat comprises beveled edges surrounding a core of higher density material.

7. A massage mat system comprising:
a mat comprising an upper surface, the upper surface comprising a substantially planar portion surrounded by a left border region, a right border region, and a rear border region extending from the left border region to the right border region, wherein the left border region, the right border region, and the rear border region project upwardly from the substantially planar portion at an incline; and
a massage ball located on the mat, wherein the massage ball defines a portion of a sphere that projects upwardly from the upper surface of the mat.

8. The massage mat system of claim 7, wherein the substantially planar portion of the upper surface inclines from a front edge of the mat toward the rear border region.

9. The massage mat system of claim 7, wherein the massage ball comprises a ball-shaped massage roller located within a recess in the upper surface of the mat.

10. The massage mat system of claim 9, further comprising:
a massage roller holder located in the recess; and
a massage roller cover, wherein the massage roller cover is configured to retained the ball-shaped massage roller in the recess between the massage roller holder and the massage roller cover.

11. The mat system of claim 7, wherein:
the mat defines a width of between about 700 mm and about 1,100 mm; and
the mat defines a length of between about 400 mm and about 800 mm.

12. A massage mat system comprising:
a mat having an upper surface;
a first track and a second track defined in the upper surface; and
a massage roller, wherein the massage roller includes a first wheel and a second wheel configured to roll within the first track and the second track, respectively.

13. The massage mat system of claim 12, wherein the first track is dimensioned to receive a first portion of the first wheel while a second portion of the first wheel protrudes from the second track above the upper surface of the mat.

14. The massage mat system of claim 13, wherein the second track is dimensioned to receive a first portion of the second wheel while a second portion of the second wheel protrudes from the second track above the upper surface of the mat.

15. The mat system of claim 12, wherein the massage roller comprises a body disposed between the first wheel and the second wheel, the body comprising at least one surface feature.

16. The mat system of claim 15, wherein the at least one surface feature comprises one of ridges or bumps.

17. The mat system of claim 13, wherein:
the mat defines a width of between about 700 mm and about 1,100 mm; and
the mat defines a length of between about 400 mm and about 800 mm.

18. The mat system of claim 13, wherein: the first and second tracks each comprise an insert received within a void in the mat, wherein the mat and the insert are different materials.

19. The mat system of claim 13, wherein the mat comprises beveled edges surrounding a core of higher density material.
